(19) United States
(12) Patent Application Publication
(10) Pub. No.: US 2023/0288220 A1
(43) Pub. Date: Sep. 14, 2023

(54) METHOD AND APPARATUS FOR DETERMINING CONNECTIONS BETWEEN ANIMATE OBJECTS

(71) Applicant: HERE GLOBAL B.V., EINDHOVEN (NL)

(72) Inventors: Jerome BEAUREPAIRE, Nantes (FR); Marko TUUKKANEN, Schlenzer (DE)

(73) Assignee: HERE GLOBAL B.V., EINDHOVEN (NL)

(21) Appl. No.: 17/690,549

(22) Filed: Mar. 9, 2022

(51) Int. Cl. G01C 21/36; G01C 21/00

(52) U.S. Cl. CPC G01C 21/3667; G01C 21/3811; G01C 21/3815; G01C 21/3859; G01C 21/387; G01C 21/3889

(57) ABSTRACT

A method, apparatus, and user interface for providing a connection detection system is disclosed. For example, image data of at least one animate object is obtained, and an indicator of relationship for the animate object is determined based on the obtained image data. One or more road segments is then associated with the determined indicator to update a map layer of a geographic database.

### TECHNOLOGICAL FIELD

An example embodiment relates generally to a method, apparatus, computer readable storage medium, user interface and computer program product for determining connections between animate objects and, more particularly, for determining connections between animate objects based upon image data of the animate objects.

### BACKGROUND

Modern vehicles include a plurality of different types of sensors for collecting a wide variety of information. These sensors include location sensors, such as global positioning system (GPS) sensors, configured to determine the location of the vehicle. Based upon the location of the vehicle, a variety of navigational, mapping and other services may be provided for manually driven vehicles as well as the provision of navigation and control of autonomous or semi-autonomous vehicles. Other examples of sensors include cameras or other imaging sensors that capture images of the environment including objects in the vicinity of the vehicle. The images that are captured may be utilized to determine the location of the vehicle with more precision. A more precise determination of the vehicle location may be useful in conjunction with the provision of navigational, mapping and other informational services for a manually driven vehicle. Additionally, the more precise determination of the vehicle location may provide for the improved navigation and control of an autonomous or semi-autonomous vehicle by taking into account the location of other objects, such as other vehicles, in proximity to the vehicle carrying the sensors.

The sensors on board vehicles therefore collect a wide variety of data that may be utilized for various purposes. However, these sensors currently on board vehicles do have limitations and do not collect all of the different types of information that would be useful in various applications.

### BRIEF SUMMARY

A method, apparatus, computer readable storage medium, user interface, and computer program product are provided in accordance with an example embodiment to determine connections between animate objects. In this regard, the method, apparatus, computer readable storage medium, and computer program product of an example embodiment may utilize image data collected of animate objects to determine and predict one or more connections for said object. The reliance upon the collection and analysis of image data may supplement the information provided by other sensors and allow for the provision of different information, such as the type of animate object (e.g., a human, dog, robot, etc.) that is useful for a variety of applications. As an example, the determination of connections between animate objects may be useful in relation to the provision of more relevant information to the vehicle and/or the driver of the vehicle. Such uses include routing information, alerts, etc. By way of another example, the identification and/or prediction of connection between animate objects may also be useful for federal, state, local or other governmental or regulatory officials that design and maintain the roads and sidewalks.

Another embodiment may be described as a method for providing a connection detection system comprising obtaining image data of at least one animate object and determining an indicator of relationship for the animate object based on the obtained image data. The image data may be obtained from a vehicle camera system, traffic cameras, etc. The system in this embodiment may then identify one or more road segments and associate the determined indicator with one or more related road segments to update a map layer of a geographic database. The embodiment above may further comprise receiving an indication of a location of the animate object and identifying one or more points of interest (POI) proximate the location of the vehicle. Once a relevant POI has been identified the system may also determine a level of risk associated with the determined indicator and one or more points of interest and updating a map layer with the level of risk. The system may also identify and associate risk with additional relevant POIs.

The system in this example may utilize the connection data for various purposes including providing alerts or route guidance to an end user on one or more end user devices (e.g., smartphone, tablet, in-vehicle displays, etc.). The determined indicator may also be used by the system to examine similarly situated road segments to identify other potential areas of risk.

Yet another embodiment may be described as an apparatus configured to determine connections between animate objects, the apparatus comprising at least one processor and at least one memory storing computer program code, the at least one memory and the computer program code configured to, with the processor, cause the apparatus to at least obtain image data of at least one animate object and determine an indicator of relationship for the animate object based on the obtained image data. The apparatus in this embodiment may then identify one or more road segments and associate the determined indicator with one or more related road segments to update a map layer of a geographic database. The apparatus above may further comprise receiving an indication of a location of the animate object and identifying one or more points of interest (POI) proximate the location of the vehicle. Once a relevant POI has been identified the apparatus may also determine a level of risk associated with the determined indicator and one or more points of interest and updating a map layer with the level of risk. The apparatus may also identify and associate risk with additional relevant POIs.

The apparatus in this example may utilize the connection data for various purposes including providing alerts or route guidance to an end user on one or more end user devices (e.g., smartphone, tablet, in-vehicle displays, etc.). The connection data may also be used by the apparatus to examine similarly situated road segments to identify other potential areas of risk.

Still yet another embodiment may be described as a user interface for providing a user with a route to a destination, the interface configured to receive input from the user that indicates a destination and then access a geographic database to obtain data that represent roads in a region in which the motor vehicle is operating. The user interface will then determine a route to the destination by selecting road segments to form a continuous path to the destination and display the determined route to the user wherein the determined route avoids at least one road segment in response to connection data for at least one animate object. The route determined for the vehicle in this example may avoid one or more points of interest proximate the location of the vehicle.

The user interface may utilize image data captured from vehicle camera systems, traffic cameras, etc. when generating the connection data. The user interface may be displayed on an end user device and/or in a motor vehicle (e.g., a heads-up display, etc.). The user interface in this example may display route guidance, alerts, etc. in response to the determined indicator.

Also, a computer program product may be provided. For example, a computer program product comprising instructions which, when the program is executed by a computer, cause the computer to carry out the steps described herein.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment;

FIG. 2 is a block diagram of a geographic database of an example embodiment of the apparatus;

FIG. 3A is a flowchart illustrating the operations performed, such as by the apparatus of FIG. 1, in order for an apparatus to identify a determined indicator of relationship for an animate object;

FIG. 3B is a flowchart illustrating the operations performed, such as by the apparatus of FIG. 1, in order for an apparatus to display route guidance to an end user;

FIG. 3C is a flowchart illustrating the operations performed, such as by the apparatus of FIG. 1, in order to train machine learning models to predict indicators of relationships for animate objects; and

FIG. 4 is a graphical representation of a road upon which a passenger sedan and animate object are present with a POI proximate to the road.

### DETAILED DESCRIPTION

Some embodiments of the present invention will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A system, method, apparatus, user interface, and computer program product are provided in accordance with an example embodiment to determine connections between animate objects based on image data of the animate objects. In order to determine the connection between animate objects, the system, method, apparatus, non-transitory computer-readable storage medium, and computer program product of an example embodiment are configured to obtain image data of at least one animate object and determining an indicator of relationship for the animate object based on the obtained image data. The image data may be obtained from a vehicle camera system, traffic cameras, etc. The system in this embodiment may then identify one or more road segments and associate the determined indicator with one or more related road segments to update a map layer of a geographic database.

The system, apparatus, method, etc. described above may be any of a wide variety of computing devices and may be embodied by either the same or different computing devices. The system, apparatus, etc. may be embodied by a server, a computer workstation, a distributed network of computing devices, a personal computer or any other type of computing device. The system, apparatus, etc. configured to predict connections between animate objects may similarly be embodied by the same or different server, computer workstation, distributed network of computing devices, personal computer or other type of computing device.

Alternatively, the system, etc. may be embodied by a computing device on board a vehicle, such as a computer system of a vehicle, e.g., a computing device of a vehicle that supports safety-critical systems such as the powertrain (engine, transmission, electric drive motors, etc.), steering (e.g., steering assist or steer-by-wire), and/or braking (e.g., brake assist or brake-by-wire), a navigation system of a vehicle, a control system of a vehicle, an electronic control unit of a vehicle, an autonomous vehicle control system (e.g., an autonomous-driving control system) of a vehicle, a mapping system of a vehicle, an Advanced Driver Assistance System (ADAS) of a vehicle), or any other type of computing device carried by the vehicle. Still further, the apparatus may be embodied by a computing device of a driver or passenger on board the vehicle, such as a mobile terminal, e.g., a personal digital assistant (PDA), mobile telephone, smart phone, personal navigation device, smart watch, tablet computer, or any combination of the aforementioned and other types of portable computer devices.

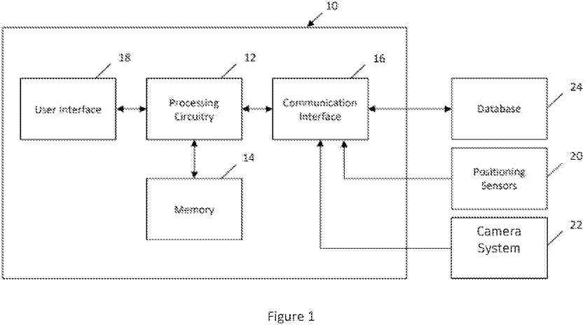

Regardless of the manner in which the system, apparatus, etc. is embodied, however, an apparatus 10 includes, is associated with, or is in communication with processing circuitry 12, memory 14, a communication interface 16 and optionally a user interface 18 as shown in FIG. 1. In some embodiments, the processing circuitry (and/or coprocessors or any other processors assisting or otherwise associated with the processing circuitry) can be in communication with the memory via a bus for passing information among components of the apparatus. The memory can be non-transitory and can include, for example, one or more volatile and/or non-volatile memories. In other words, for example, the memory may be an electronic storage device (for example, a computer readable storage medium) comprising gates configured to store data (for example, bits) that can be retrievable by a machine (for example, a computing device like the processing circuitry). The memory can be configured to store information, data, content, applications, instructions, or the like for enabling the apparatus to carry out various functions in accordance with an example embodiment of the present disclosure. For example, the memory can be configured to buffer input data for processing by the processing circuitry. Additionally, or alternatively, the memory can be configured to store instructions for execution by the processing circuitry.

The processing circuitry 12 can be embodied in a number of different ways. For example, the processing circuitry may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry can include one or more processing cores configured to perform independently. A multi-core processor can enable multiprocessing within a single physical package. Additionally, or alternatively, the processing circuitry can include one or more processors configured in tandem via the bus to enable independent execution of instructions, pipelining and/or multithreading.

In an example embodiment, the processing circuitry 12 can be configured to execute instructions stored in the memory 14 or otherwise accessible to the processing circuitry. Alternatively, or additionally, the processing circuitry can be configured to execute hard coded functionality. As such, whether configured by hardware or software methods, or by a combination thereof, the processing circuitry can represent an entity (for example, physically embodied in circuitry) capable of performing operations according to an embodiment of the present disclosure while configured accordingly. Thus, for example, when the processing circuitry is embodied as an ASIC, FPGA or the like, the processing circuitry can be specifically configured hardware for conducting the operations described herein. Alternatively, as another example, when the processing circuitry is embodied as an executor of software instructions, the instructions can specifically configure the processing circuitry to perform the algorithms and/or operations described herein when the instructions are executed. However, in some cases, the processing circuitry can be a processor of a specific device (for example, a computing device) configured to employ an embodiment of the present disclosure by further configuration of the processor by instructions for performing the algorithms and/or operations described herein. The processing circuitry can include, among other things, a clock, an arithmetic logic unit (ALU) and/or one or more logic gates configured to support operation of the processing circuitry.

The apparatus 10 of an example embodiment can also include the communication interface 16 that can be any means such as a device or circuitry embodied in either hardware or a combination of hardware and software that is configured to receive and/or transmit data from/to other electronic devices in communication with the apparatus, such as a database 24 which, in one embodiment, comprises a map database that stores data (e.g., one or more map objects, POI data, etc.) generated and/or employed by the processing circuitry 12. Additionally, or alternatively, the communication interface can be configured to communicate in accordance with various wireless protocols including Global System for Mobile Communications (GSM), such as but not limited to Long Term Evolution (LTE), 3G, 4G, 5G, etc. In this regard, the communication interface can include, for example, an antenna (or multiple antennas) and supporting hardware and/or software for enabling communications with a wireless communication network. In this regard, the communication interface can include, for example, an antenna (or multiple antennas) and supporting hardware and/or software for enabling communications with a wireless communication network. Additionally, or alternatively, the communication interface can include the circuitry for interacting with the antenna(s) to cause transmission of signals via the antenna(s) or to handle receipt of signals received via the antenna(s). In some environments, the communication interface can alternatively or also support wired communication and/or may alternatively support vehicle to vehicle or vehicle to infrastructure wireless links.

In certain embodiments, the apparatus 10 can be equipped or associated with one or more positioning sensors 20, such as one or more GPS sensors, one or more accelerometer sensors, one or more light detection and ranging (LiDAR) sensors, one or more radar sensors, one or more gyroscope sensors, and/or one or more other sensors. Any of the one or more sensors may be used to sense information regarding movement, positioning and location, and/or orientation of the apparatus for use, such as by the processing circuitry 12, in navigation assistance and/or autonomous vehicle control, as described herein according to example embodiments.

In certain embodiments, the apparatus 10 may further be equipped with or in communication with one or more camera systems 22. In some example embodiments, the one or more camera systems 22 can be implemented in a vehicle or other remote apparatuses.

For example, the one or more camera systems 22 can be located upon a vehicle or proximate to it (e.g., traffic cameras, etc.). While embodiments may be implemented with a single camera such as a front facing camera in a consumer vehicle, other embodiments may include the use of multiple individual cameras at the same time. A helpful example is that of a consumer sedan driving down a road. Many modern cars have one or more cameras installed upon them to enable automatic braking and other types of assisted or automated driving. Many cars also have rear facing cameras to assist with automated or manual parking. In one embodiment of the current system, apparatus, method, etc. these cameras are utilized to capture images of animate objects as the sedan travels. The system takes these captured images (via the camera systems 22) and analyzes them to determine the types of animate objects present. Certain types of animate objects may be detected via any functional means including but not limited to the relative size of animate objects present in each location, movement patterns of the objects, etc.

The data captured concerning the animate objects present may also come from traffic cameras, security cameras, or any other functionally useful source (e.g., historic data, satellite images, etc.).

The analysis of the image data of the animate objects may be carried out by a machine learning model. This model may utilize any functionally useful means of analysis to identify animate objects on a given roadway, road segment, or general area. The system, in this embodiment, may then identify one or more additional animate objects in a given area and determine if any connections are present for the one or more animate objects utilizing the machine learning model. In some embodiments, the system may also examine relevant proximate points of interest (POIs) which could impact the behavior of the animate objects.

The locations of the vehicles, animate objects, and any relevant points of interest (POIs) which are utilized by various embodiments of the system may each be identified in latitude and longitude based on a location of the vehicle using a sensor, such as a GPS sensor to identify the location of the vehicle. The POIs identified by the system may also be detected via the camera systems 22. For example, a large human (e.g., a parent) may be walking with a small human (e.g., their child) by a park and in some embodiments of the present innovation the system may examine the image data to identify the park as a likely relevant point of interest.

In certain embodiments, information detected by the one or more cameras can be transmitted to the apparatus 10, such as the processing circuitry 12, as image data. The data transmitted by the one or more cameras can be transmitted via one or more wired communications and/or one or more wireless communications (e.g., near field communication, or the like). In some environments, the communication interface 16 can support wired communication and/or wireless communication with the one or more camera sensors.

The apparatus 10 may also optionally include a user interface 18 that may, in turn, be in communication with the processing circuitry 12 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processing circuitry may comprise user interface circuitry configured to control at least some functions of one or more user interface elements such as a display and, in some embodiments, a plurality of speakers, a ringer, one or more microphones and/or the like. The processing circuitry and/or user interface circuitry embodied by the processing circuitry may be configured to control one or more functions of one or more user interface elements through computer program instructions (for example, software and/or firmware) stored on a memory accessible to the processing circuitry (for example, memory 14, and/or the like).

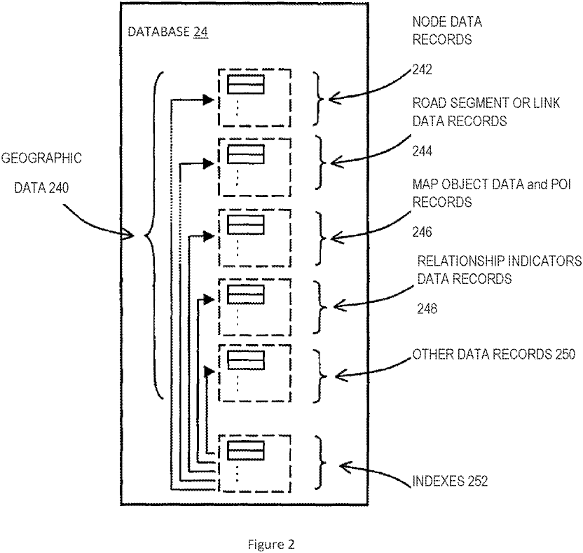

Turning to FIG. 2, the map or geographic database 24 may include various types of geographic data 240. This data may include but is not limited to node data 242, road segment or link data 244, map object and point of interest (POI) data 246, relationship indicators data records 248, or the like (e.g., other data records 250 such as traffic data, sidewalk data, etc.). Other data records may include computer code instructions and/or algorithms for executing a machine learning model that is capable of providing a prediction of adverse road locations. The other records may further include verification data indicating: (1) whether a verification of a prediction for an adverse road location was conducted; (2) whether the verification validates the prediction; or (3) a combination thereof.

In one embodiment, the following terminology applies to the representation of geographic features in the database 24. A “Node” — is a point that terminates a link, a “road/line segment” — is a straight line connecting two points., and a “Link” (or “edge”) is a contiguous, non-branching string of one or more road segments terminating in a node at each end. In one embodiment, the database 24 follows certain conventions. For example, links do not cross themselves and do not cross each other except at a node. Also, there are no duplicated shape points, nodes, or links. Two links that connect each other have a common node.

The map database 24 may also include cartographic data, routing data, and/or maneuvering data as well as indexes 252. According to some example embodiments, the road segment data records may be links or segments representing roads, streets, or paths, as may be used in calculating a route or recorded route information for determination of one or more personalized routes. The node data may be end points (e.g., intersections) corresponding to the respective links or segments of road segment data. The road link data and the node data may represent a road network, such as used by vehicles, cars, trucks, buses, motorcycles, bikes, scooters, and/or other entities.

Optionally, the map database may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database can include data about the POIs and their respective locations in the POI records. The map database may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database.

The map database 24 may be maintained by a content provider e.g., the map data service provider and may be accessed, for example, by the content or service provider processing server. By way of example, the map data service provider can collect geographic data and dynamic data to generate and enhance the map database and dynamic data such as traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device, as they travel the roads throughout a region.

The map database 24 may be a master map database, such as an HD map database, stored in a format that facilitates updates, maintenance, and development. For example, the master map database or data in the master map database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the map database 24 may be a master geographic database, but in alternate embodiments, a client-side map database may represent a compiled navigation database that may be used in or with end user devices to provide navigation and/or map-related functions. For example, the map database may be used with the mobile device to provide an end user with navigation features. In such a case, the map database can be downloaded or stored on the end user device which can access the map database through a wireless or wired connection, such as via a processing server and/or a network, for example.

The data records for relationship indicators 248 may include various points of data such as, but not limited to: relative size of animate objects, movement patterns, the time of day, any sensor data acquired from one or more sensors of a vehicle; travel data of a vehicle, GPS coordinates for a given detected relationship, etc.

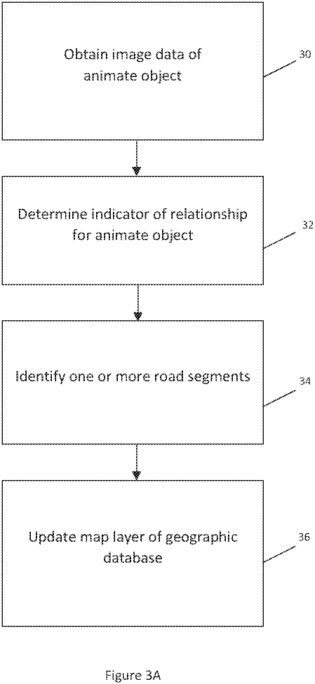

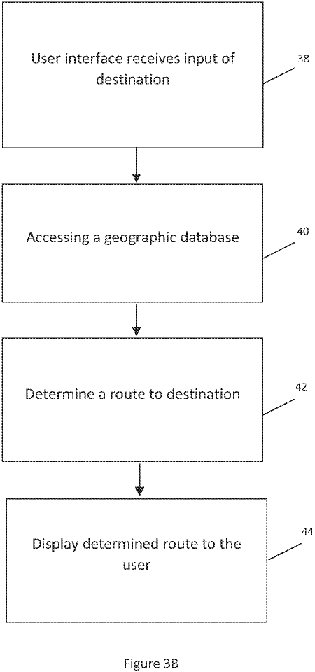

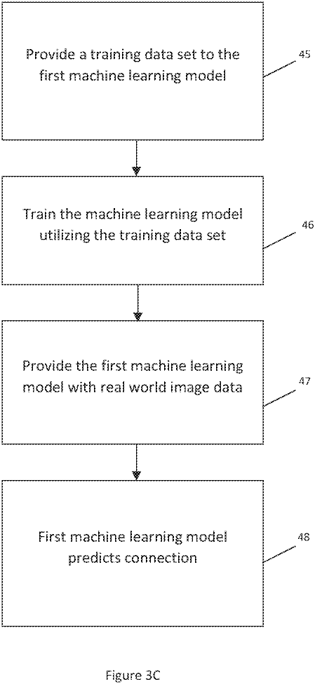

FIG. 3A is a flowchart which demonstrates how the apparatus 10 identifies animate objects and determines if a connection is present. More, fewer, or different acts or steps may be provided. At a first step (block 30) the apparatus may obtain one or more images of at least one animate object. The images may be obtained from the camera of an end user device such as a smart phone, the camera system of a vehicle, or even traffic cameras, etc. The apparatus may be trained to analyze the image data (see FIG. 3C) via machine learning model or any other functionally capable means to identify animate objects. The animate objects may be humans, robots, pets, wild animals, etc. and once these images are obtained, the apparatus may then determine at least one indicator of relationship for a given animate object, for example, at another step (block 32). The indicator of relationship may be any indication of connection between a given animate object and another object or thing. It should be noted the apparatus may determine actual physical connections for animate objects (e.g., image data of a leash is captured and identified by the apparatus) and may also determine non-physical connections. For example, some movement patterns indicate a connection between objects.

An example of movement patterns the apparatus might recognize are those between a human and dog on a leash. When on a leash, a dog will move in certain directions in response to the leash and follow certain movement patterns. When on a leash, the dog may be pulled by the human and the dog’s neck might move in response to the human’s arm movement. The apparatus might also examine movement of the animate objects through the surrounding environment so, if the dog was on a leash, it would not be able to walk with its human past a tree with the tree passing between them (as much would indicate the dog is off leash). The type of leash (e.g., extendable, short, long, etc.) may even be identified by the apparatus based off these movements without having to specifically identify a leash via image data analysis.

The apparatus is also capable of analyzing movement patterns which do not involve physical connection between animate objects. For example, two humans walking together down a sidewalk at a normal rate of speed in the middle of the day likely know each other and are likely walking together. In a similar situation two people may be headed down a sidewalk one walking and one running. In this situation the dissimilar speed and distance between the two people indicates they are not connected / coupled. The apparatus can distinguish between the two situations listed above (the runner may run into the street while the walkers likely will not) and other movement patterns and act upon this information in various ways.

Once an indicator of relationship is determined for a given animate object, the apparatus may then identify one or more road segments (block 34) upon which the animate object(s) are present. The identification of the relevant road segments may be done via a vehicle’s onboard GPS (see FIG. 1) or any other functional means. Once identified, the apparatus may then update a map layer of a geographic database (block 36). The updating of the map layer may include but is not limited to identifying/associating locations of the identified relationships with certain road segments and then providing some type of data indicator or flag to mark that road segment or attribute (metadata) that can be used as an identifier when needed to access or retrieve the road segments for various navigation functions. This data can also be used to generate alerts and analyze other similarly situated road segments for the potential risk animate objects might pose. The road segment data may also include sidewalk data or areas included in/associated with the road segment records or the road segment records may represent path records such as sidewalks, hiking trails, etc.

Turning to FIG. 3B, the apparatus 10 may support a user interface 18 (as shown in FIG. 1). More, fewer, or different acts or steps may be provided. At a first step, the user interface may receive an input of destination from an end user (block 38). This input of destination may be received via an end user device graphical user interface (GUI) running upon a smartphone, tablet, integrated vehicle navigation system, etc. Once a destination is input, the apparatus may then access a geographic database (block 40) and determine a route to the input destination (block 42). The determined route may, in some embodiments, avoid at least one road segment in response to a determined connection (an indicator of relationship) for at least one animate object. As mentioned above, the determination of connection may be based on any functionally capable means including identification of an actual physical connection and/or prediction of a connection based on movement pattern analysis, etc. Notwithstanding how the apparatus generates a determination of connection, this information may then be used to route the end user towards or away from certain road segments when generating a route. The route determined by the apparatus 10 may then be displayed to then end user (block 44) via the same or a different user interface.

The apparatus can take any number of additional actions (or in place of) what is called for in block 44. For example, the apparatus may provide audio guidance instead of a visual display. The navigation instructions may also be provided to an autonomous vehicle for routing (for example, without any display to the user).

Referring now to FIG. 3C, the operations performed, such as by the apparatus 10 of FIG. 1, in order to train a machine learning model to detect and predict indicators of relationships (e.g., connections) between animate objects. More, fewer, or different acts or steps may be provided. As shown in block 45, the apparatus includes means, such as the processing circuitry 12, memory 14, the communication interface 16 or the like, for providing a training data set that includes a plurality of training examples. In this regard, the training data set may be provided by access by the processing circuitry of the training data set stored by the memory. Alternatively, the training data set may be provided by access by the processing circuitry to a database 24 or other memory device that either may be a component of the apparatus or may be separate from, but accessible to the apparatus, such as the processing circuitry, via the communication interface. It should be noted the system apparatus may utilize more than one machine learning model to carry out the steps described herein.

In accordance with an example embodiment, the apparatus 10 also includes means, such as the processing circuitry 12, the memory 14 or the like, configured to train a machine learning model utilizing the training data set (block 46). The machine learning model, as trained, is configured to detect and predict connections between animate objects. The prediction may be based at least in part upon image data of the animate objects.

The apparatus 10, such as the processing circuitry 12, may train any of a variety of machine learning models to identify animate objects based upon a single or plurality of images. Examples of machine learning models that may be trained include a decision tree model, a random forest model, a neural network, a model that employs logistic regression or the like. In some example embodiments, the apparatus, such as the processing circuitry, is configured to separately train a plurality of different types of machine learning models utilizing the same training data including the same plurality of training examples. After having been trained, the apparatus, such as the processing circuitry, is configured to determine which of the plurality of machine learning models predicts animate objects based upon image data with the greatest accuracy. The machine learning model that has been identified as most accurate is thereafter utilized.

In one example, the machine learning model may be a deep learning neural network computer vision model that utilizes image data of animate objects to automatically identify them. A training example for this first machine learning model may include image data of known classes or types of animate objects. Known animate objects could include, but are not limited to adult humans, children, dogs, other pets, companion robots, wild animals, handicapped individuals, etc. Various images of different types of animate objects are provided to the machine learning model to train and improve its accuracy.

In some example embodiments, a balance or trade-off between the accuracy with which the animate objects are identified and the efficiency with which the machine learning model identifies the objects is considered. For example, a first set of images may produce the most accurate identification, but a second combination of images may produce an identification of objects that is only slightly less accurate, but that is significantly more efficient in terms of its prediction. Thus, the second combination of images that provide for sufficient, even though not the greatest, accuracy, but does so in a very efficient manner may be identified by the apparatus 10, such as the processing circuitry 12, as the preferred images to be provided to the machine learning model in order to identify animate objects in subsequent instances.

In some embodiments, a training example also includes information regarding a map object, such as a map object that is located at the location at which the image data was captured. One example of a map object is a bridge, and another example of a map object is a railroad crossing. A wide variety of other map objects may exist including, for example, manhole covers, transitions between different types of road surfaces, various forms of infrastructure, or the like. As described in more detail below, the map object that is included in a training example may be determined or provided in various manners. For example, the map object may be defined, either manually or automatically, by reference to a map database 24 and identification of a map object at the same location or at a location proximate, such as within a predefined distance of, the location at which the corresponding image data was captured. The training example may also include point of interest (POI) data. A POI may be something like a park, school, bus stop, etc. Relevant POIs may also be defined, either manually or automatically, by reference to a map database 24 and identification of a POI at the same location or at a location proximate, such as within a predefined distance of, the location at which the corresponding image data was captured. The location of relevant POIs and/or map objects may be found by GPS coordinates or any other functionally capable means.

Various other types of data may also be utilized to train the machine learning model. Such additional data may include but is not limited to data concerning typical movements between or in relation to various types of animate objects. For example, a dog walking on a leash may typically stay close to its human and follow the human’s path. This can be contrasted with a dog off leash which might wander around untethered and pose a risk to passing traffic. The leash mentioned above may also pose a risk as it should be avoided by bikers, joggers, etc. that might run into the leash itself instead of the dog or human. The movements between animate objects might also not be dependent on a physical connection. For example, children walking next to a parent or other adult typically stay close to the parent. Children are not typically on leashes, but the movement of the adult does typically impact the child’s movement thus creating a connection between the two animate objects.

Yet other various types of data may also be utilized when training the machine learning model including map geometry data, historic data, etc.

Once trained, the machine learning model may then be provided various real-world data as mentioned in block 47 and used to predict connections between animate objects based on these various data points and others (block 48).

A non-limiting example of the apparatus 10 determining connection between animate objects is that of a passenger car driving down a roadway during a school day. As the car drives down the road, it comes upon a school with children outside playing with a teacher supervising them. The apparatus 10 will identify the children and teacher via images captured by the car’s camera system 22. The image data captured is provided to the machine learning model which, when trained, will identify the animate objects in proximity to the roadway. The apparatus 10 in this situation may also identify one or more map objects, POIs, etc. in proximity to the children. One such POI, in this example, could be the school located on the road. The type of animate object (e.g., children and adult) determination and the relevant POI identified may be provided to the machine learning model. The machine learning model will then be able to predict a connection between the animate objects present. In this example, since the children are playing outside a school and being supervised the apparatus 10 may predict that the children are connected to one another, the teacher, or the school and thus the risk of them venturing into the street is low.

The machine learning model in this example makes its determination based on a combination of specific factors (map data, image data, etc.), and the model predicts the presence of such a relationship because specific factors in a specific combination or configuration are present. The factors in this example may include the image data of children, image data of an adult, the POI data (about the school) as well as time of day data, etc. This set of data, provided to the model matches (or is like) the factors used in the training process (in this example). This allows the machine learning model to predict a relationship given the location, time of day, animate objects present, etc.

The determination of a connection in this example (an indicator of relationship) can then be utilized in various ways. The apparatus 10 may alert the driver of the sedan (and others) via graphical user interface that there could be a risk ahead. The apparatus may also update one or more map layers and/or databases to account for this risk. In some embodiments, the predicted connection (or lack thereof) caused by the children playing may be used to activate autonomous or highly assisted driving features. For example, if the sedan discussed above had self-driving capabilities the apparatus 10 could activate the self-driving mode in response to the children present to insure none are struck by the passing sedan.

The determined connection data may be utilized in other ways. For example, the apparatus 10 may provide to the end user updated route guidance which avoids certain areas with connected animate objects. Continuing with the example above, the apparatus 10 may look at existing map data to determine a better route which avoids the playing children all together.

As mentioned before, the apparatus 10 features one or more machine learning models. This model and other data may be used by the apparatus 10 to not only analyze real time driving situations as mentioned above but also examine existing map data to identify other similarly situated roadways. These similar roadways will have similar POIs, map objects, etc. So, for example, if there was another school close to a roadway with children playing, the apparatus 10 may be able to detect such a similar roadway and provide alerts, route guidance, etc. to an end user to avoid potential risks.

Other examples of the apparatus 10 at work include crowded urban settings. Urban settings are frequently hampered by many different forms of animate objects. Humans walking their dogs, bikers, parents with strollers and kids, and many other forms of animate objects share the same sidewalks, bike lanes, and roadways. In one embodiment, the apparatus 10 may be configured to run on an end user device such as a smart phone or tablet. The apparatus 10, running on an end user device may be used by not only automobile drivers but also drivers of motorcycles, mopeds, bicycles, scooters, joggers, etc. In one no limiting example, a delivery driver on a bike may utilize the apparatus via their smart phone mounted on the bike. The smartphone’s camera, traffic cameras, other vehicle’s camera, etc. may be utilized by the apparatus to capture image data and monitor for different types of animate objects. As the end user rides around on their bike, they may encounter a popular restaurant along a street. The camera system 22 may capture images of the restaurant and its patrons as the biker approaches. The apparatus will then confirm the types of animate objects present outside the restaurant on the sidewalk (and near the street) via the machine learning model.

Once the animate objects have been identified, the apparatus will determine if any connections are present for these animate objects. In this example, there may be several people standing outside the restaurant waiting to enter. One of these people may have a dog with them on a leash. The apparatus may determine the presence of both the dog and its owner then also examine the movement patterns between the two to determine if the dog is on a leash or not. As the owner moves their arm, the dog is pulled along by this motion indicating a physical connection of a leash.

In this example, another person in line may be standing with their child. The apparatus may detect their presence and examine the size difference between the two as well as their behavior to determine if they are connected. In this situation, the child follows the moment of the parent walking forward in line, indicating that the parent and child are connected. Since the dog and child are both connected to an adult the apparatus may generate an alert but elect not to route away from the restaurant. The apparatus can then display the alert to the bike rider informing them of the potential hazard and mention the risk is low.

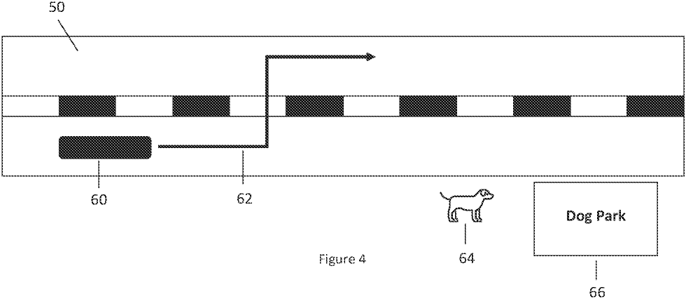

Turning to FIG. 4, some of the examples discussed above are illustrated. Specifically, a sedan 60 is shown driving down a roadway 50. Next to the roadway 50 there is an unaccompanied dog 64 and a dog park 66 ahead. As shown in FIG. 4, the sedan 60 is utilizing the apparatus 10 to predict if the dog 64 is connected to anyone or anything in the area. The apparatus identifies the dog via images from the camera system 22, traffic cameras, etc. and feeds those images into the machine learning model which determines the type of animate object (e.g., a dog). The apparatus then takes this data along with relevant other information such as the behavior/movement of the dog and feeds it back to the machine learning model (or to another model) to determine if the dog is likely alone or not.

It should be noted that the sedan 60 in this example represents any vehicle. Such vehicles may be standard gasoline powered vehicles, hybrid vehicles, an electric vehicle, a fuel cell vehicle, and/or any other mobility implement type of vehicle (e.g., bikes, scooters, etc.). The vehicle includes parts related to mobility, such as a powertrain with an engine, a transmission, a suspension, a driveshaft, and/or wheels, etc. The vehicle may be a non-autonomous vehicle or an autonomous vehicle. The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one embodiment, the vehicle may be assigned with an autonomous level. An autonomous level of a vehicle can be a Level 0 autonomous level that corresponds to a negligible automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

In one embodiment, a graphical user interface (GUI) may be integrated in the vehicle, which may include assisted driving vehicles such as autonomous vehicles, highly assisted driving (HAD), and advanced driving assistance systems (ADAS). Any of these assisted driving systems may be incorporated into the GUI. Alternatively, an assisted driving device may be included in the vehicle. The assisted driving device may include memory, a processor, and systems to communicate with the GUI. In one embodiment, the vehicle may be an HAD vehicle or an ADAS vehicle. An HAD vehicle may refer to a vehicle that does not completely replace the human operator. Instead, in a highly assisted driving mode, a vehicle may perform some driving functions and the human operator may perform some driving functions. Such vehicle may also be driven in a manual mode in which the human operator exercises a degree of control over the movement of the vehicle. The vehicle may also include a completely driverless mode. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In this example, there is a dog park (i.e., a POI) 66 adjacent to the roadway 50. The apparatus 10 then uses all this information (e.g., a dog present, untether movement behavior, dog not in the dog park) via the one or more machine learning models to determine if the dog is likely connected to anyone or anything. In this example, it is determined by the apparatus that the dog is unaccompanied. Based off this information, the apparatus may provide to the driver of the sedan 60 an alert (e.g., a high-risk alert) along with route guidance 62 to avoid the dog. The route guidance 62 provided by the apparatus 10 is shown as an arrow which represents a suggested way to avoid the dog which may have escaped from the dog park (e.g., drive around it in the other lane). This data could also then be used by the apparatus to provide an alert or route guidance to another user on a bike in the area. Since there is no leash present the bike rider can ride by the dog without risk of running into a leash.

In this example, the dog park POI adjacent to the given roadway signifies any POI within reasonable proximity to the animate object (dog) such that the POI could impact behavior. There are many factors which can be considered by the apparatus to determine if a given POI is within reasonable range to be considered. Such data points were discussed above and can include but are not limited to map geometry data, historic data, and/or various other types of data. The proximity to the animate object may be set at a certain threshold (e.g., within 100 feet, 1 mile, etc.) and the apparatus may examine multiple relevant POIs within the distance threshold for animate objects. For example, if multiple parks are ahead of a bike rider along a given roadway in the next half mile the apparatus may determine there is an increased risk to the rider based on the presence of multiple POIs.

It should be noted that the examples above are non-limiting and the apparatus, user interface, etc. may be used by pedestrians. For example, if a pedestrian is walking down a hiking trail and approaching a strange dog, the system can determine if this dog is leased based on its movements. Many end users may wish to avoid unleashed dogs for personal safety, allergy concerns, etc. In embodiments such as this the apparatus may operate in locations (without the vehicles need for vehicles) via trail cameras, end user smart phones, security cameras, etc.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 14 of an apparatus 10 employing an embodiment of the present invention and executed by the processing circuitry 12. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Furthermore, in some embodiments, additional optional operations may be included. Modifications, additions, or amplifications to the operations above may be performed in any order and in any combination.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing a connection detection system comprising:
obtaining image data of at least one animate object;
determining an indicator of relationship for the animate object based on the obtained image data;
identifying one or more road segments; and
associating the determined indicator with one or more identified road segments to update a map layer of a geographic database.

2. The method according to claim 1, further comprising receiving an indication of a location of the animate object and identifying one or more points of interest proximate the location of the vehicle.

3. The method according to claim 2, further comprising determining a level of risk associated with the determined indicator and one or more points of interest and updating a map layer with the level of risk.

4. The method according to claim 2, further comprising identifying at least one additional point of interest based on road segments similarly situated to the previously identified points of interest.

5. The method according to claim 1, further comprising providing an alert in response to the determined indicator to at least one end user device.

6. The method according to claim 1, further comprising obtaining the image data of the animate object from a vehicle camera system.

7. The method according to claim 1, further comprising providing route guidance in response to the determined indicator.

8. An apparatus configured to predict connection between animate objects, the apparatus comprising at least one processor and at least one memory storing computer program code, the at least one memory and the computer program code configured to, with the processor, cause the apparatus to at least:
obtaining image data of at least one animate object;
determining an indicator of relationship for the animate object based on the obtained image data;
identifying one or more road segments; and
associating the determined indicator with one or more identified road segments to update a map layer of a geographic database.

9. The apparatus according to claim 8, wherein the at least one memory and the computer program code are further configured to, with the processor, cause the apparatus to receive an indication of a location of the vehicle, wherein the at least one memory and the computer program code are configured to, with the processor, cause the apparatus to obtain the location of the vehicle, and wherein the at least one memory and the computer program code are configured to, with the processor, cause the apparatus to identify one or more points of interest proximate the location of the vehicle.

10. The apparatus according to claim 9, further comprising determining a level of risk associated with the determined indicator and one or more points of interest and updating a map layer with the level of risk.

11. The apparatus according to claim 9, further comprising determining a level of risk associated with the determined indicator and one or more points of interest and updating a map layer with the level of risk.

12. The apparatus according to claim 8, wherein the at least one memory and the computer program code are configured to, with the processor, cause the apparatus to obtain the image data via a vehicle camera system.

13. The apparatus according to claim 8, wherein the at least one memory and the computer program code are configured to, with the processor, cause the apparatus to generate route guidance.

14. The apparatus according to claim 8, further comprising identifying at least one additional point of interest based on road segments similarly situated to the previously identified points of interest.

15. A user interface for providing a user with a route to a destination, comprising the steps of:
receiving input upon a user device from the user that indicates a destination;
accessing a geographic database to obtain data that represent roads in a region in which the user device is operating;
determining a route to the destination by selecting road segments to form a continuous path to the destination; and
displaying the determined route or portion thereof to the user,
wherein the determined route avoids at least one road segment in response to a determined connection for at least one animate object.

16. The user interface of claim 15, wherein the route determined for the vehicle avoids one or more points of interest proximate the location of the vehicle.

17. The user interface of claim 15, wherein the determined connection is derived at least in part on image data obtained via a vehicle camera system.

18. The user interface of claim 15, wherein the user interface provides an alert in response to the determined connection.

19. The user interface of claim 15, wherein the user interface is displayed on an end user device.

20. The user interface of claim 15, wherein the user interface is displayed in a motor vehicle.
